(19) United States
(12) Patent Application Publication
(10) Pub. No.: US 2023/0385816 A1
(43) Pub. Date: Nov. 30, 2023

(54) GOLD CARD TRANSACTION MANAGEMENT SYSTEM AND METHOD

(71) Applicant: Lien Hao Chuang, Kaohsiung (TW)

(72) Inventor: Lien Hao Chuang, Kaohsiung (TW)

(21) Appl. No.: 17/898,762

(22) Filed: Aug. 30, 2022

(30) Foreign Application Priority Data
May 27, 2022 (TW) 111119942

(51) Int. Cl. G06Q 20/38; G06Q 20/40

(52) U.S. Cl. CPC G06Q 20/3829; G06Q 20/4014

(57) ABSTRACT

A gold card transaction management system and method, wherein a one-time decryption request is sent to the gold card through an information device (such as a mobile device loaded with an APP) for obtaining the card serial number stored in the gold card. Meanwhile, a member serial number and the card serial number are sent to the transaction server for verification. When the transaction server verifies that the user is the cardholder of the gold card, the information device is enabled to generate a public key and a private key corresponding to each other for the gold card to encrypt and decrypt the gold information stored in the gold card. In this way, the system can determine that the user is the cardholders and conduct transactions based on the gold information.

### BACKGROUND OF INVENTION

### (1) Field of the Present Disclosure

The present disclosure relates to a gold card transaction management system and method, and more particularly to a gold card transaction management system and method employing the asymmetric encryption algorithm to conduct the gold card transaction management.

### (2) Brief Description of Related Art

The traditional gold trading is accustomed to use identification certificates, quality guarantees or marks on the commodity itself to identify the authenticity of gold. With the development of technology and the Internet, the current gold transaction is no longer carried out in traditional trading methods. For example, gold is embedded in the card, and the gold transactions are recorded by radio frequency identification technology, so as to ensure the fairness of gold transactions and the authenticity of gold. Although the radio frequency identification technology brings convenience, it also has problems such as easy leakage/tracking, theft or forgery of personal data.

For the gold transaction, it is not easily to prove that the person who holds the gold is the person who owns the gold whether it is a traditional physical gold transaction or a gold card transaction using radio frequency identification technology. When the gold card is lost, it is difficult to prove its identity if it is stolen by an unscrupulous person. Accordingly, how to determine that the user who conducts the transaction with the gold card (using radio frequency identification technology) is the cardholder, how to determine the composition of gold and related resumes when the gold card is used during the transaction, or when the gold card is accidentally lost or stolen, and how to effectively speed up the liquidity of gold transactions, these are the issues to be resolved.

### SUMMARY OF INVENTION

It is a primary object of the present disclosure to provide a gold card transaction management system and method that ensures that the gold card equipped with the radio frequency identification technology can determine that the user who conducts the gold card transaction is the cardholder, the composition of gold and the related trading history, no matter when the transaction is performed or when the gold card is lost or stolen. Furthermore, the liquidity of gold transactions can be effectively speeded up.

According to the present disclosure, a gold card transaction management method comprises the following steps:
sending a decryption request having a first identification code to the gold card through an information device;
generating a second identification code based on the decryption request and transmitting the second identification code and a card serial number to the information device through the gold card;
automatically selecting and transmitting one of the card serial number, a member serial number, and a device serial number to a transaction server through the information device;
comparing the above-mentioned serial numbers with a checklist through the transaction server;
generating and transmitting an encryption request to the information device when it is confirmed that one of the serial numbers or a combination thereof is recorded in the checklist through the transaction server;
automatically selecting and converting one of the first identification code, the second identification code, the card serial number, the membership serial number, or a combination thereof into a public key and a private key corresponding to each other based on the encryption request by use of an asymmetric encryption algorithm through the information device; meanwhile, the public key is transmitted to the gold card;
executing a preset cryptographic hash function through the gold card, encrypting the gold information with the public key to generate an encryption data, and transmitting the encryption data to the information device; and decrypting the encryption data by use of the private key through the information device to obtain the gold information.

In order to ensure whether the user operating the system of the present disclosure is the cardholder of the gold card, the system can be set such that the information device select and transmit at least the member serial number and card serial number to the transaction server. In this way, the transaction server can check the user's member serial number and confirm if there is a card serial number registered with the gold card. Next, in order to ensure the uniqueness of the user who operates the system of the present disclosure and the gold card to be sensed this time, the system can be set in such a way that the information device converts at least the first identification code and the second identification code into a public key and a private key corresponding to each other. Since both the first identification code and the second identification code are generated at the current moment, it is difficult for them to be stolen at the same moment or later.

In order to prevent the gold card from being stolen, the gold card can use a preset hash operator and a random generator to execute a preset cryptographic hash function to encrypt the second identification code and the card serial number for generating a hash data which is then sent to the information device. In this way, the user operating the system of the present disclosure can obtain the second identification code and the card serial number only by decrypting the preset hash value pre-stored in the cardholder's membership account.

In order to prevent the gold card from being stolen, the gold card can be protected by physical anti-theft method. When the gold card is disassembled and damaged by external force, the internal induction coil and circuit of the wireless communication element will be damaged together. As a result, the data inside the gold card cannot be copied or used. In this way, it is difficult to be stolen.

In order to prevent the gold card from being used without permission when the cardholder loses it accidentally, the transaction server can encrypt the card serial number of the gold card lost by the cardholder with the public key sensed last time based on a loss report request, and make the operation. Meanwhile, the user who operates the system of the present disclosure is requested to transmit the private key (generated when the lost gold card was sensed last time) for decryption.

In order to facilitate the management of the public key by the cardholder and improve the efficiency of the gold card in encrypting the gold information, the public key is converted into a public key fingerprint by a cryptographic hash function before the information device transmits the public key to the gold card. In this way, the length of the public key is shortened, thereby improving the efficiency in encrypting the gold card.

When the user wants to trade the gold card held by himself, he can use the information device and the gold card to perform the above-mentioned steps to enter into the member account and obtain the gold information. Then, through the user interface module, functions such as setting up member accounts, trading gold cards, recording commemorative videos, reporting lost gold cards, etc. can be performed. In this way, the gold card can become a pass for logging into the transaction management system of the present disclosure. The transaction management system of the present disclosure also only recognizes the gold card as the gold card for this designated transaction.

### BRIEF DESCRIPTION OF THE DRAWINGS

FIG. 1 is a block diagram of a structure of the present disclosure;

FIG. 2 is a flow chart of a gold card transaction management method according to the present disclosure;

FIG. 3 is a schematic diagram I of the implementation of the present disclosure;

FIG. 4 is a schematic diagram II of the implementation of the present disclosure;

FIG. 5 is a schematic diagram III of the implementation of the present disclosure;

FIG. 6 is a schematic diagram IV of the implementation of the present disclosure;

FIG. 7 is a schematic diagram V of the implementation of the present disclosure;

FIG. 8 is a schematic diagram VI of the implementation of the present disclosure;

FIG. 9 is a schematic diagram VII of the implementation of the present disclosure; and

FIG. 10 is a schematic diagram VIII of the implementation of the present disclosure.

### DETAILED DESCRIPTION OF PREFERRED EMBODIMENTS

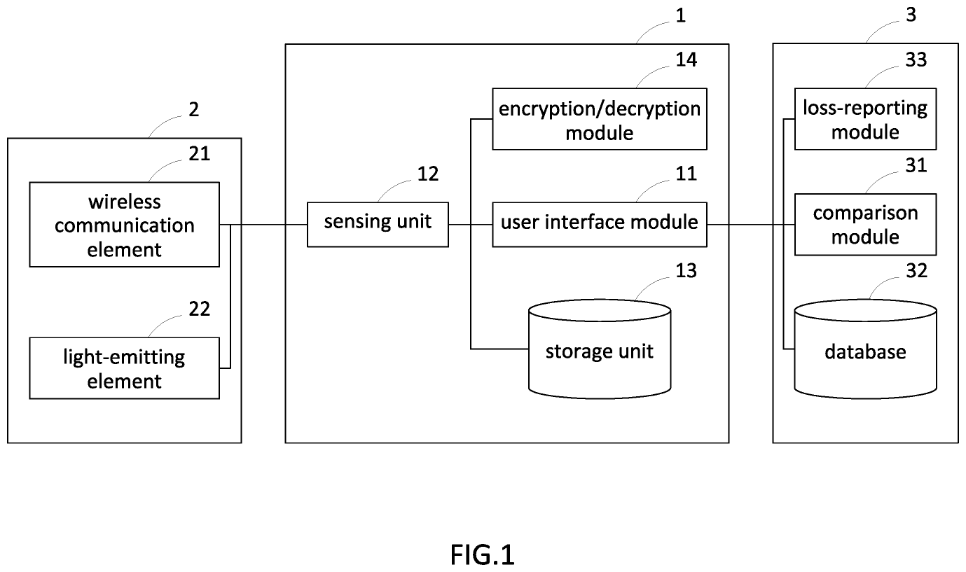

Referring to FIG. 1, a gold card transaction management system according to the present disclosure includes an information device 1, a gold card 2, and a transaction server 3 all of which are informationally connected to each other. The information device 1 may be one of a mobile phone, a tablet computer, a personal computer, etc., but not limited thereto.

The information device 1 includes a user interface module 11, a sensing unit 12, a storage unit 13, and an encryption/decryption module 14. All of the above-mentioned modules and the units are informationally connected to each other. The user interface module 11 and the encryption/decryption module 14 may be driven by a processor. The processor may be one or a combination of central processing unit, graphics processing unit, micro processing unit, and micro control unit.

The user interface module 11 can be an app (application) or a web page set up in a web browser, so that the user can connect to the transaction server 3 via the Internet through the information device 1. The user interface module 11 can receive information generated by the user operating the information device 1. The sensing unit 12 can be a reader capable of scanning one-dimensional barcodes or two-dimensional barcodes, or sensing by near-field communication or radio frequency identification, thereby reading information recorded/stored in one-dimensional barcodes, two-dimensional barcodes, wireless communication components, etc. The storage unit 13 can be one or a combination of solid state disk or solid state drive, hard disk drive, static random access memory, random access memory, or cloud drive, etc. for storing electronic data. The encryption/decryption module 14 can use an asymmetric encryption algorithm or a hash encryption algorithm to generate a key, and use the key or the hash value stored in the key to perform encryption/decryption.

The gold card 2 includes a wireless communication element 21. The wireless communication element 21 can be embedded with a plurality of logic gates (such as a hash operator and a random generator) and store a card serial number and a preset cryptographic hash function. The data structure thereof can be {Count, Card ID, Data}, wherein Count is the number of times the gold card 2 has been read, Card ID can be a card serial number corresponding to one of the cardholder's membership serial numbers, and Data can be a gold information. The gold information may include one or a combination of a gold product serial number, a weight, a purity, a purchase time, a source of raw materials, or an exchange rate at the time of purchase.

The transaction server 3 includes a comparison module 31, a database 32, and a loss-reporting module 33. The aforementioned modules are informationally connected with each other. The comparison module 31 and the loss-reporting module 33 can be driven by another processor. The processor may be one or a combination of central processing unit, graphics processing unit, micro processing unit, and micro control unit.

The comparison module 31 can be used to check whether the data transmitted by the information device 1 is consistent with the data stored in the database 32. The database 32 can be one or a combination of solid state disk or solid state drive, hard disk drive, static random access memory, random access memory, or cloud drive, etc. for storing electronic data. The loss-reporting module 33 can encrypt the gold card 2 when the cardholder loses it, so as to protect the gold card 2 from being stolen by unscrupulous persons.

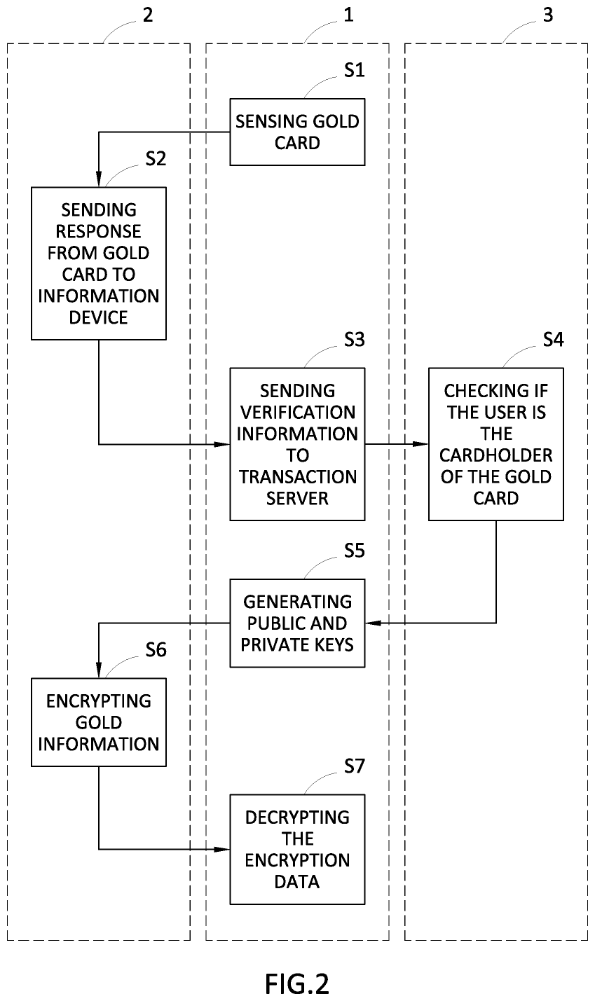

As shown in FIG. 2, a gold card transaction management method includes the following steps:

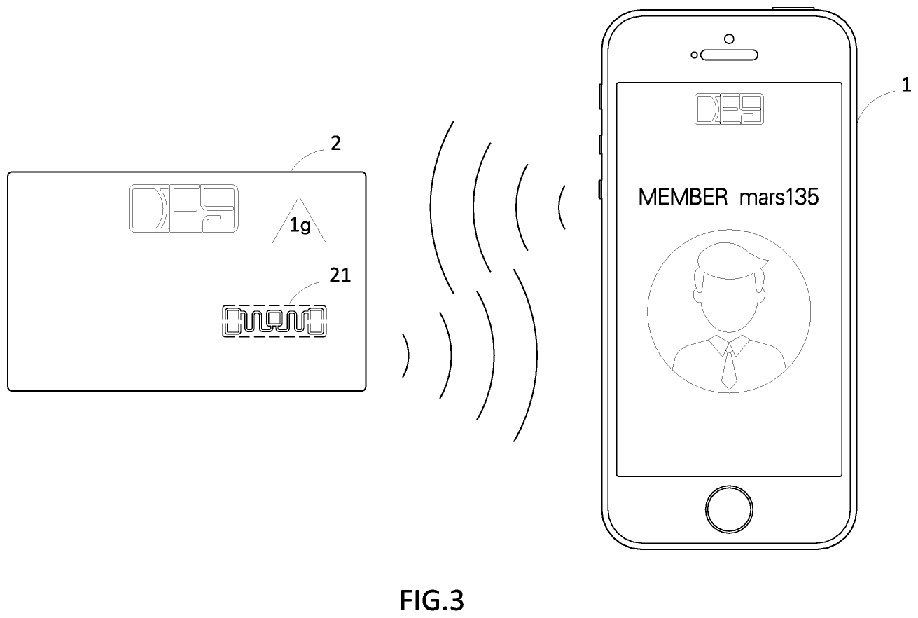

Step S1 of sensing gold card: As shown in FIG. 3, when the user wants to know the current value of the gold card 2, he can operate the information device 1, log into a member account through the user interface module 11, and place the gold card 2 into a sensing range of the sensing unit 12. Thereafter, the sensing unit 12 sends a decryption request of a first identification code generated by the encryption/decryption module 14 to the gold card 2. The first identification code owns a one-time property and can be one of a 128-bit random code, a one-time password obtained by time-based one-time password algorithm, or a combination thereof. More specifically, the one-time password can be created by executing a cryptographic hash function through the encryption/decryption module 14 by use of a member serial number, a device serial number in the storage unit 13, a current timestamp, or a combination thereof. The member serial number may be the account number, the password, or the biometric identification corresponding to the user's member account while the device serial number may be the device number of the information device 1 currently operated by the user.

Step S2 of sending response from gold card to information device 1: When the gold card 2 receives the decryption request, the wireless communication element 21 can generate a second identification code through the pre-embedded hash operator and random generator based on the decryption request and send the second identification code and a card serial number to the information device 1. The second identification code can be one of a 128-bit random code, a one-time password obtained by time-based one-time password algorithm, or a combination thereof. More specifically, the one-time password can be a cryptographic hash function generated by the wireless communication element 21 by use of a card serial number and a current timestamp.

Step S3 of sending verification information to transaction server: When the information device 1 receives the second identification code and the card serial number, the user interface module 11 automatically selects one of the card serial number, the member serial number, the device serial number, or a combination thereof to send to the transaction server 3.

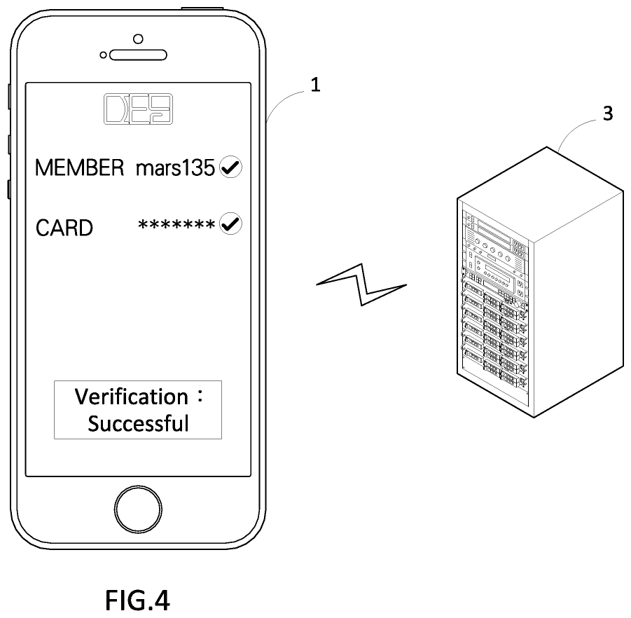

Step S4 of checking if the user is the cardholder of the gold card: Referring to FIG. 4, when the transaction server 3 receives one of the card serial number, the member serial number, the device serial number, or a combination thereof, the comparison module 31 compares the card serial number, the member serial number, the device serial number, or a combination thereof with a checklist in the database 32. When the comparison module 31 confirms that one the card serial number, the member serial number, the device serial number or a combination thereof is recorded in the checklist (the comparison operation is performed by the transaction server 3 and the progress is displayed by the information device 1), an encryption request is generated and sent to the information device 1. The checklist can include one of a basic information (personal information such as name, phone number, ID number, etc.) of the user's membership account, the member serial number, a combination thereof, the card serial number of the gold card 2 held by the user, and the device serial number of the information device 1 held by the user, etc., but not limited thereto.

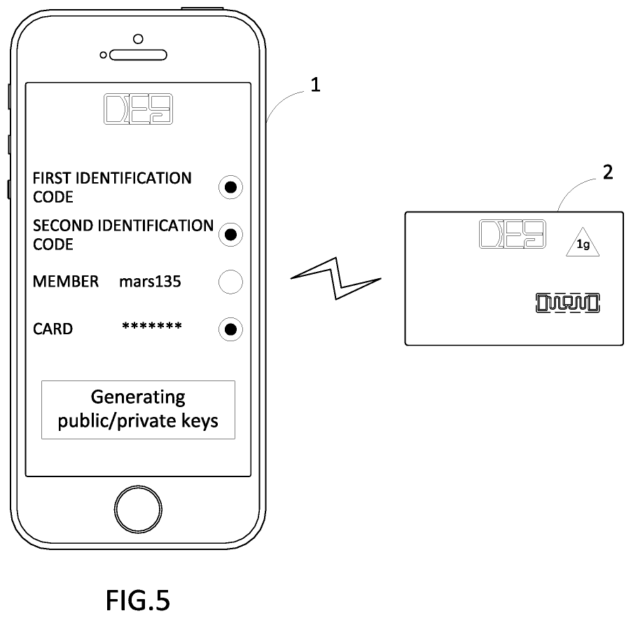

Step S5 of generating public and private keys: Referring to FIG. 5, when the information device 1 receives the encryption request, the encryption/decryption module 14 automatically selects and converts one of the first identification code, the second identification code, the card serial number, the member serial number, or the combination thereof into corresponding public/private keys based on the encryption request by using an asymmetric encryption algorithm. Meanwhile, the public key is transmitted to the gold card 2 through the sensing unit 12 and stored in the transaction server 3 through the user interface module 11. The asymmetric encryption algorithm can be one of RSA, ElGamal, Rabin, DSA, and ECDSA.

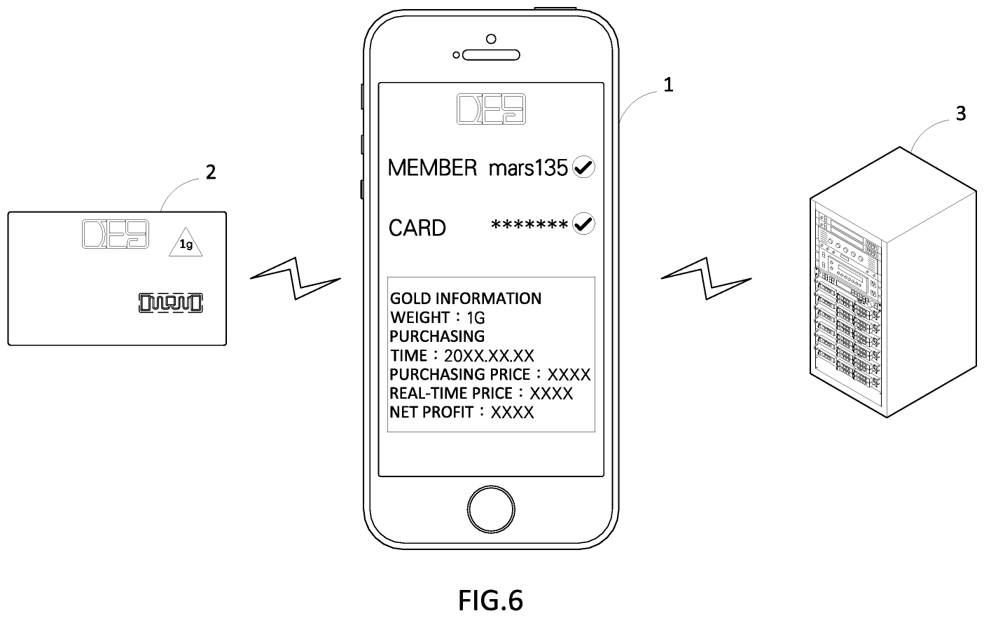

Step S6 of encrypting gold information: Referring to FIG. 6, when the gold card 2 receives the public key, the wireless communication element 21 executes the preset cryptographic hash function through the pre-embedded hash operator and the random generator, and encrypts the gold information with the public key to generate an encryption data, and transmits the encryption data to the information device 1

Step of S7 of decrypting the encryption data: When the information device 1 receives the encryption data, the encryption and decryption module 14 uses the private key to decrypt the encryption data to obtain the gold information, so that the user can know the value of the gold card 2, for example, the number of grains of gold, time, price, etc. at the time of purchase. Moreover, the user interface module 11 can further retrieve the real-time price of gold from the transaction server 3, so as to let the user know the net profit brought by the gold card 2.

In one embodiment, when the information device 1 receives the second identification code and the card serial number, the user interface module 11 selects and transmit the member serial number and the card serial number to the transaction server 3. In this way, the transaction server 3 can confirm whether the user is the cardholder of the gold card 2 through the member serial number of the user who wants to know the value of the gold card 2 and the card serial number of the gold card 2 that has been sensed this time. If so, the process proceeds to the next step. If not, the information device 1 is enabled to display an error notification. In another embodiment, the user can also manually select and transmit one of the card serial number, the member serial number, the device serial number, or a combination thereof to the transaction server 3 through the user interface module 11.

In one embodiment, when the transaction server 3 confirms that the user is the cardholder of the gold card 2 and sends the encryption request to the information device 1, the encryption/decryption module 14 converts at least the first identification code and the second identification code into corresponding public/private keys. In this way, the information device 1 can use the one-time first identification code and the second identification code to generate a one-time public key and private key, thereby ensuring the uniqueness of the user who wants to know the value of the gold card 2 this time and the gold card 2 sensed this time. In another embodiment, the user can also manually select and transmit one of the first identification code, the second identification code, the card serial number, the membership serial number, or a combination to the transaction server through the user interface module 11 to the transaction server 3.

In one embodiment, before the gold card 2 transmits the second identification code and the card serial number to the information device 1, a pre-embedded hash operator and a random generator are used to execute a preset cryptographic hash function in advance for encrypting the second identification code and the card serial number to create a hash information which is then transmitted to the information device 1. Thereafter, a decryption is conducted by the encryption/decryption module 14 according to a preset hash value in the storage unit 13. If the preset hash value is the same as that recorded in the cardholder's membership account, the second identification code and the card serial number can be obtained.

In one embodiment, before the information device 1 transmits the public key to the gold card 2, the public key is converted into a public key fingerprint by a cryptographic hash function. Then, the public key fingerprint is transmitted to the gold card 2. In this way, the wireless communication element 21 can encrypt the gold information with the public key fingerprint. Thereafter, the encryption/decryption module 14 can also decrypt the public key fingerprint according to the preset hash value in the storage unit 13 to obtain the gold information. The cryptographic hash function can be a secure hash algorithm. In this way, the cardholder can easily manage the public key. Meanwhile, the efficiency in encrypting the gold information of the gold card 2 can also be improved.

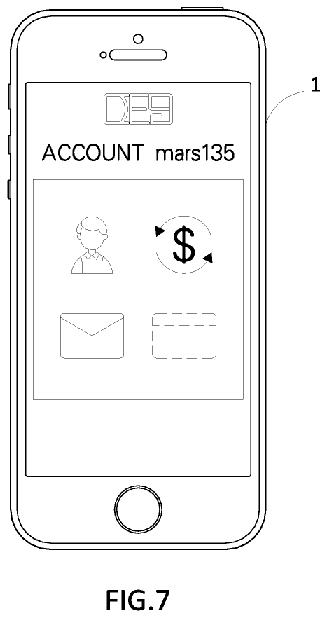

In an embodiment, referring to FIG. 7, when the user wants to trade the gold card 2 held by himself, he can use the information device 1 and the gold card 2 to perform the above-mentioned steps to enter into the member account and obtain the gold information. Then, through the user interface module 11, functions such as setting up member accounts, trading gold cards, recording commemorative videos, reporting lost gold cards, etc. can be performed. In this way, the gold card 2 can become a pass for logging into the transaction management system of the present disclosure. The transaction management system of the present disclosure also only recognizes the gold card 2 as the gold card 2 for this designated transaction.

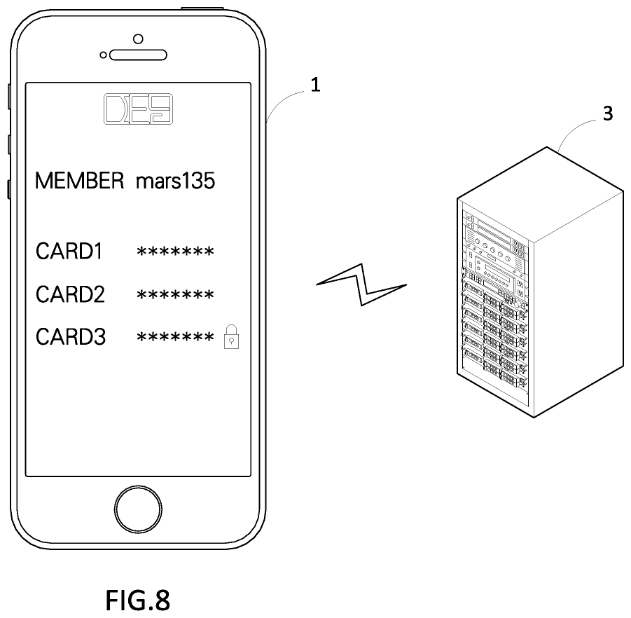

In one embodiment, referring to FIG. 8, when the cardholder loses the gold card 2 he holds, a loss report request can be sent through the information device 1 to the transaction server 3. Based on the loss reporting request, the loss-reporting module 33 encrypts the card serial number of the gold card 2 lost by the cardholder with the latest public key in the database 32. The latest public key refers to the public key generated when the lost gold card 2 was sensed last time. When the transaction server 3 proceeds to confirm whether the encrypted serial number of the gold card is recorded in the checklist, the information device 1 is requested to transmit the private key (generated when the lost gold card 2 was sensed last time) for decryption. If so, the loss report will be eliminated; if not, it is not allowed for the information device 1 to read.

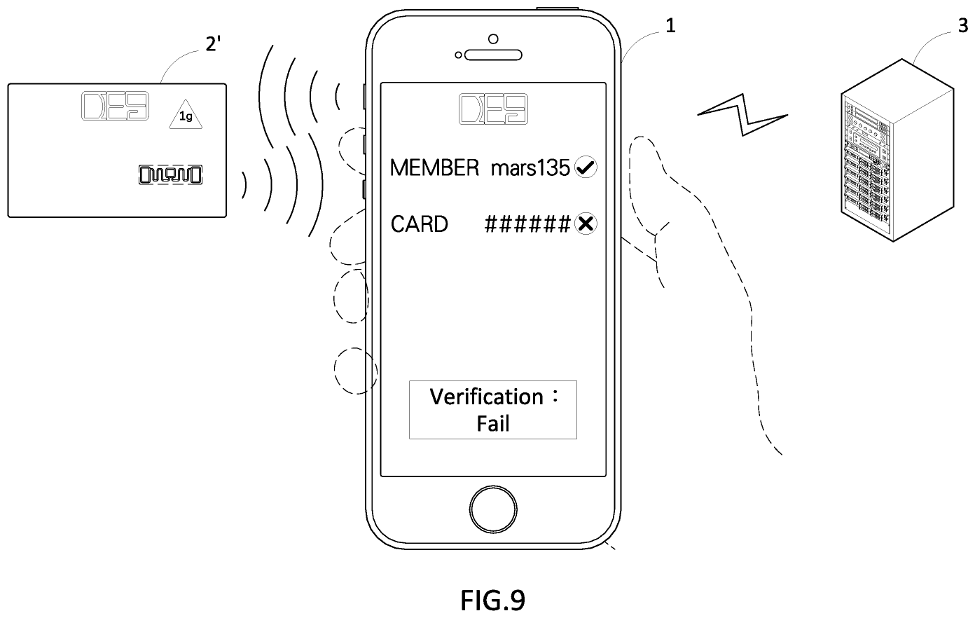

In one embodiment, referring to FIG. 9, when the user uses the information device 1 to sense the gold card 2′ that is not held by the user, the user interface module 11 transmits the card serial number and the membership serial number to the transaction server 3. Next, the comparison module 31 compares the card serial number and the member serial number with the checklist to confirm whether the user is the cardholder of the gold card 2′. If so, the process proceeds to the next step. If not, the information device 1 is enabled to display an error notification.

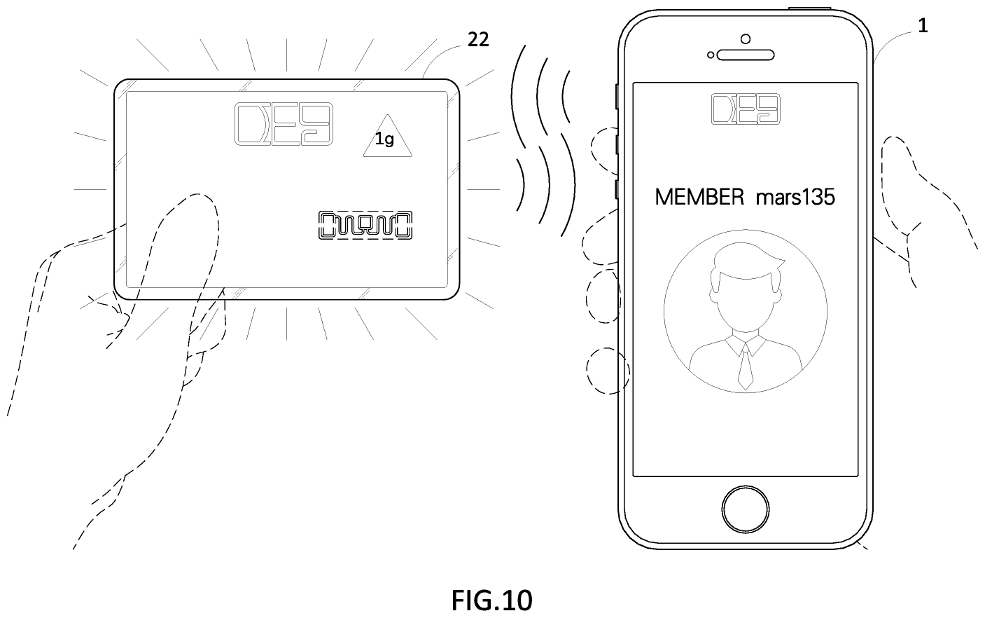

In one embodiment, referring to FIG. 10, when the user senses the gold card 2 through the information device 1, a light-emitting element 22 emits light of different colors to notify the user according to different conditions, so that the user can intuitively recognize if the operation is correct. For example, when the gold card 2 receives the decryption request, the light-emitting element 22 emits blue display light. When the information device 1 displays an error notification, the light-emitting element 22 emits a red warning light simultaneously, so as to let the user know that this is an erroneous operation.

In one embodiment, the wireless communication element 21 has an easy-tear line, and the easy-tear line is composed of a plurality of disconnecting slits and a plurality of connecting members of low-strength structures. When the gold card 2 is disassembled and damaged by external force, the wireless communication element 21 is disassembled into a connection part and a circuit part along the easy tearing line. In this way, the internal induction coil and circuit will be damaged, and the data inside the card cannot be copied or used.

According to the gold card transaction management system and method of the present disclosure, a one-time decryption request is transmitted to the gold card through the information device for obtaining the card serial number stored within the gold card. Meanwhile, the member serial number and the card serial number are transmitted to the transaction server for verification. When the transaction server verifies that the user is the cardholder of the gold card, the information device generates the corresponding public key and private key for decrypting the gold information stored in the gold card. In this way, the system can determine that the user is the cardholder and conduct transactions based on the gold information. Meanwhile, it can indeed achieve that the gold card equipped with the radio frequency identification technology can determine that the user who conducts the gold card transaction is the cardholder, the composition of gold and the related trading history, no matter when the transaction is performed or when the gold card is lost or stolen. Furthermore, the liquidity of gold transactions can be effectively speeded up.

### REFERENCE SIGN

1 information device
11 user interface module
12 sensing unit
13 storage unit
14 encryption/decryption module
2 gold card
21 wireless communication element
22 light-emitting element
3 transaction server
31 comparison module
32 database
33 loss-reporting module
S1 sensing gold card
S2 sending response from gold card to information device
S3 sending verification information to transaction server
S4 checking if the user is the cardholder of the gold card
S5 generating public and private keys
S6 encrypting gold information
S7 decrypting the encryption data

What is claimed is:

1. A gold card transaction management method for retrieving gold information of a gold card and conducting transactions, comprising:
sending a decryption request having a first identification code to the gold card through an information device;
generating a second identification code based on the decryption request and transmitting the second identification code and a card serial number to the information device through the gold card;
automatically selecting and transmitting one of the card serial number, a member serial number, a device serial number, or a combination thereof to a transaction server through the information device;
generating and transmitting an encryption request to the information device when the transaction server confirms that one of the card serial number, the membership serial number, or the device serial number, or a combination thereof is recorded in a checklist;
automatically selecting and converting one of the first identification code, the second identification code, the card serial number, the membership serial number, or a combination thereof into a public key and a private key corresponding to each other based on the encryption request by use of an asymmetric encryption algorithm through the information device, wherein the public key is transmitted to the gold card;
executing a preset cryptographic hash function through the gold card, encrypting the gold information with the public key to generate an encryption data, and transmitting the encryption data to the information device; and
decrypting the encryption data by use of the private key through the information device to obtain the gold information.

2. The gold card transaction management method as claimed in claim 1, wherein the information device selects at least the card serial number and the membership serial number and transmits them to the transaction server.

3. The gold card transaction management method as claimed in claim 1, wherein at least the first identification code and the second identification code are selected to be converted into the public key and the private key when the information device generates the public key and the private key.

4. The gold card transaction management method as claimed in claim 1, wherein, before the gold card transmits the second identification code and the card serial number to the information device, the gold card executes the preset cryptographic hash function for encrypting the second identification code and the card serial number to create a hash information which is then transmitted to the information device, whereupon a decryption is conducted by the information device according to a preset hash value for obtaining the second identification code and the card serial number.

5. The gold card transaction management method as claimed in claim 1, wherein, before the information device transmits the public key to the gold card, the public key is converted into a public key fingerprint by a cryptographic hash function; then, the public key fingerprint is transmitted to the gold card, whereupon the gold card encrypts the gold information with the public key fingerprint.

6. The gold card transaction management method as claimed in claim 1, wherein a loss report request can be sent through the information device to the transaction server, and wherein, based on the loss reporting request, the transaction server encrypts the card serial number with the latest public key; thereafter, when the transaction server confirms that the card serial number is recorded in the checklist, the information device is requested to transmit the private key for decryption.

7. The gold card transaction management method as claimed in claim 1, wherein the first identification code and the second identification code are one of a 128-bit random code, a one-time password obtained by time-based one-time password algorithm, or a combination thereof.

8. The gold card transaction management method as claimed in claim 7, wherein the one-time password of the first identification code is created by executing an cryptographic hash function through the information device by use of one or a combination of the member serial number and the device serial number, as well as a current timestamp.

9. The gold card transaction management method as claimed in claim 7, wherein the one-time password of the second identification code is created by executing the preset cryptographic hash function through the gold card by use of the card serial number and a current timestamp.

10. The gold card transaction management method as claimed in claim 1, wherein, when the gold card receives the decryption request, or when the transaction server confirms that one of the card serial number, the member serial number, the device serial number, or a combination thereof are not recorded in the checklist, the gold card emits light of different colors according to different conditions.

11. A gold card transaction management system for conducting transactions by use of a gold information, comprising:
a gold card having a wireless communication element storing the gold information and a card serial number;
a transaction server having a comparison module for generating an encryption request when it is confirmed that one of the card serial number, a member serial number, a device serial number, or a combination thereof is recorded in a checklist; and
an information device informationally connected with the gold card and the transaction server, having:
a sensing unit for transmitting a decryption request having a first identification code to the wireless communication element, the wireless communication element generating a second identification code based on the decryption request and transmitting the second identification code and the card serial number to the information device;
a user interface module for automatically selecting and transmitting one of the card serial number, the membership serial number, the device serial number, or a combination thereof to the transaction server; and
an encryption/decryption module for automatically selecting and converting one of the first identification code, the second identification code, the card serial number, the membership serial number, or a combination thereof into a public key and a private key corresponding to each other based on the encryption request by use of an asymmetric encryption algorithm, and transmitting the public key to the gold card through the sensing unit;
wherein, when the wireless communication element executes a preset cryptographic hash function, the gold information is encrypted with the public key to generate an encryption data which is then transmitted to the information device, and wherein the encryption/decryption module uses the private key to decrypt the encryption data for obtaining the gold information.

12. The gold card transaction management system as claimed in claim 11, wherein the user interface module selects at least the card serial number and the membership serial number and transmits them to the transaction server.

13. The gold card transaction management system as claimed in claim 11, wherein at least the first identification code and the second identification code are selected to be converted into the public key and the private key when the encryption/decryption module generates the public key and the private key.

14. The gold card transaction management system as claimed in claim 11, wherein, before the wireless communication element transmits the second identification code and the card serial number to the information device, the wireless communication element executes the preset cryptographic hash function for encrypting the second identification code and the card serial number to create a hash information which is then transmitted to the information device, whereupon a decryption is conducted by the encryption/decryption module according to a preset hash value for obtaining the second identification code and the card serial number.

15. The gold card transaction management system as claimed in claim 11, wherein, before the information device transmits the public key to the gold card, the public key is converted into a public key fingerprint by a cryptographic hash function; then, the public key fingerprint is transmitted to the gold card, whereupon the wireless communication element encrypts the gold information with the public key fingerprint.

16. The gold card transaction management system as claimed in claim 11, wherein the transaction server includes a loss-reporting module, and wherein, when a loss report request is sent through the information device to the transaction server, the transaction server encrypts the card serial number with the latest public key based on the loss reporting request; thereafter, when the comparison module confirms that the card serial number is recorded in the checklist, the information device is requested to transmit the private key for decryption.

17. The gold card transaction management system as claimed in claim 11, wherein the first identification code and the second identification code are one of a 128-bit random code, a one-time password obtained by time-based one-time password algorithm, or a combination thereof.

18. The gold card transaction management system as claimed in claim 17, wherein the one-time password of the first identification code is created by executing an cryptographic hash function through the encryption/decryption module by use of one or a combination of the member serial number and the device serial number, as well as a current timestamp.

19. The gold card transaction management system as claimed in claim 17, wherein the one-time password of the second identification code is created by executing the preset cryptographic hash function through the wireless communication element by use of the card serial number and a current timestamp.

20. The gold card transaction management method as claimed in claim 11, wherein, when the gold card includes a light-emitting element for emitting light of different colors according to different conditions.
